(19) United States
(12) Patent Application Publication
(10) Pub. No.: US 2024/0244714 A1
(43) Pub. Date: Jul. 18, 2024

(54) HEATING CIRCUIT AND DEVICE

(71) Applicant: Dyson Technology Limited, Wiltshire (GB)

(72) Inventors: Nathan James CROFT, Swindon (GB); Stephen John WOOLAGHAN, Swindon (GB); Frederick Stuart GROTRIAN, Swindon (GB); Benjamin John BROWN, Bristol (GB)

(73) Assignee: Dyson Technology Limited, Wiltshire (GB)

(21) Appl. No.: 18/289,483

(22) PCT Filed: Apr. 26, 2022
(86) PCT No.: PCT/GB2022/051051

§ 371 Date: Nov. 3, 2023

(30) Foreign Application Priority Data
May 6, 2021 (GB) 2106437.3

(51) Int. Cl. H05B 1/02; A45D 1/04; A45D 2/00

(52) U.S. Cl. CPC H05B 1/0252; A45D 1/04; A45D 2/001; H05B 2203/007; H05B 2203/035

(57) ABSTRACT

A heating circuit has at least three series-connected resistance-heating elements, each resistance-heating element being connected between a pair of nodes, each pair of adjacent resistance-heating elements in the series being connected via one of the nodes, each node being connectable to a voltage. Optionally, the heating circuit may have one or more switching elements to allow selective connection of one or more voltages to the resistance heating elements.

The present invention relates to heating circuits, and to devices comprising such heating circuits.

### BACKGROUND

Power control of heating circuits may be desirable in certain applications. For example, it may be desirable to control the heat of a surface heated by one or more elements forming part of the heating circuit, and/or for controlling the amount of energy output via such resistance-heating element(s).

One way in which a heating circuit may be controlled is by independent switching of parallel-connected resistance-heating elements. For example, a 1 kW element in parallel with a 2 kW element may provide a total heating output of 1 kW (just the 1 kW element turned on), 2KW (just the 2 kW element turned on) and 3 kW (both the 1 kW and 2 kW elements turned on). The number of elements, and their combinations, limits control of the heat output by such heating circuits.

Alternatively, power may be pulsed across a resistance-heating element to modulate the amount of heat generated by the heat circuit as a whole. For example, pulse width modulation of a drive current through a 1 kW resistance-heating element may allow controlled heat output of between 0 and 1 kW. Control and drive circuitry for such heating circuits may be complex and/or costly.

As an example, heat-based hair-styling devices may use a heating circuit. For example, a hair-straightening apparatus may include a pair of opposed plates that may be squeezed together while hair is pulled through them. Heat from one or both of the plates heats up the hair and allows it to be styled. Similar principles apply to a hair-curling and crimping devices.

It would be useful to provide a heating circuit enabling modulation of the temperature and/or heat output of one or more surfaces of a device, such as a hair-styling device. Alternatively, or in addition, it would also be useful to provide the ability to control the temperature and/or heat output of various surfaces of a device, such as a hairstyling device.

### SUMMARY

According to a first aspect, there is provided a heating circuit, comprising at least three series-connected resistance-heating elements, each resistance-heating element being connected between a pair of nodes, each pair of adjacent resistance-heating elements in the series being connected via one of the nodes, each node being connectable to a voltage.

Such an arrangement may provide a simple heating circuit offering a range of power outputs and/or distributions.

Each node may be connectable to a voltage such that different combinations of voltages connected to at least two of the nodes at a time allow selection of respective corresponding parallel-resistance combinations of the resistance-heating elements. As an example, such combinations may result in, relative to at least some of the other combinations:
a different combined power output of the resistance-heating elements; and/or
a different distribution of power output across the resistance-heating elements.

The heating circuit may comprise a first switching element, wherein:
a first terminal of the first switching element is connectable to a first voltage; and
a second terminal of the first switching element is connected to a first of the nodes, the first switching element being switchable to enable selective connection of the first node to the first voltage.

The use of a switching element may allow for effective control of heat output from one or more of the resistance-heating element(s).

The heating circuit may comprise a second switching element, wherein:
a first terminal of the second switching element is connectable to the first voltage or to a second voltage that is different to the first voltage; and
a second terminal of the second switching element is connected to a second of the nodes, the second switching element being switchable to enable selective connection of the second node to the first voltage or the second voltage.

The use of a second switching element may allow for additional control of heat output from one of more of the resistance-heating elements.

The first and second switching elements may be independently switchable to define multiple parallel-resistance combinations of the resistance-heating elements, wherein each combination results in, relative to at least some of the other combinations:
a different combined power output of the resistance-heating elements; and/or
a different distribution of power output across the resistance-heating elements.

The use of first and second switching elements in this way may allow more efficient and/or effective control of heat output and/or distribution.

The heating circuit may comprise a third switching element, wherein:
a first terminal of the third switching element is connectable to the first or second voltage, or to a third voltage; and
a second terminal of the third switching element is connected to one of the nodes, the third switching element being switchable to enable selective connection of the third node to the first voltage, the second voltage or the third voltage.

The use of a third switching element in this way may allow more efficient and/or effective control of heat output and/or distribution.

The second terminal of the third switching element may be connected to a node other than the first node and the second node. For example, the second terminal of the third switching element may be connected to the first node or the second node.

Connecting the third switching element in this way may allow more efficient and/or effective control of heat output and/or distribution.

The series-connected resistance-heating elements may comprise one or more additional resistance-heating elements.

The use of one or more additional resistance-heating elements may offer additional control of heat output and/or distribution.

The resistance-heating elements may be connected as a ring circuit.

Connection as a ring circuit may increase the number of possible heat output configurations of the heating circuit, and/or reduce the number of switching elements required for a desired number of heat output and/or distribution configurations.

The heating circuit may comprise at least four of the resistance-heating elements, each connected to its adjacent resistance-heating element(s) via one of the nodes.

According to a second aspect, there is provided a device comprising the heating circuit of the first aspect.

The device may comprise a heating surface having a plurality of heating zones, each of the zones being heatable by at least one of the resistance-heating elements, the heating device comprising drive circuitry for selectively driving combinations of the nodes with voltages, such that different combinations of voltages connected to at least two of the nodes at a time allow selection of respective corresponding parallel-resistance combinations of the resistance-heating elements, wherein each combination results in, relative to at least some of the other combinations:
a different combined power output of the resistance-heating elements; and/or
a different distribution of power output across the resistance-heating elements.

The heating zones may extend in a linear direction along a portion of the device, and/or may form a two-dimensional array over a portion of the device. This may allow for different heat and/or power outputs at some or all of the heating zones.

The zones may be continuous or at least partly discontinuous over the portion of the device.

The device may take the form of a hair-styling apparatus.

According to a third aspect, there is provided a hair-styling apparatus comprising:
an array of heating zones;
a heating circuit, comprising at least three series-connected resistance-heating elements, each resistance-heating element being connected between a pair of nodes, each pair of adjacent resistance-heating elements in the series being connected via one of the nodes, each resistance-heating element being arranged to heat at least one of the heating zones;
drive circuitry for selectively supplying different combinations of voltages to at least two of the nodes at a time to allow selection of respective corresponding parallel-resistance combinations of the resistance-heating elements, wherein each combination results in, relative to at least some of the other combinations:
a different combined power output of the heating zones; and/or
a different distribution of power output across the heating zones.

The hair-styling apparatus may take the form of, for example, a hair-straightening apparatus, a hair-curling apparatus, or a hair-crimping apparatus.

The device or the hair-styling apparatus may comprise one or more batteries for powering the heat elements. The battery or batteries may be rechargeable and/or replaceable. Alternatively, or in addition, the device or the hair-styling apparatus may be connectable to a source of mains power.

### BRIEF DESCRIPTION OF DRAWINGS

In order that the present invention may be more readily understood, embodiments of the invention will now be described, by way of example, with reference to the accompanying drawings, in which:

FIG. 1 is a schematic of a heating circuit in accordance with an aspect of the invention;

FIG. 2 is a schematic of a heating circuit in accordance with a further aspect of the invention;

FIG. 3a is a schematic of a heating circuit in accordance with a further aspect of the invention;

FIG. 3b is a schematic of a heating circuit in accordance with a further aspect of the invention;

FIG. 4a is a schematic of a heating circuit in accordance with a further aspect of the invention;

FIG. 4b is a schematic of a heating circuit in accordance with a further aspect of the invention;

FIG. 4c is a schematic of a heating circuit in accordance with a further aspect of the invention;

FIG. 5 is a schematic of a heating circuit in accordance with a further aspect of the invention;

FIG. 6 is a schematic of a heating circuit in accordance with a further aspect of the invention;

FIG. 7 is a schematic of a heating circuit in accordance with a further aspect of the invention;

FIGS. 8-12 are schematics of a heating circuit in accordance with a further aspect of the invention, showing various modes of operation;

FIG. 13 is a schematic of a heating circuit in accordance with a further aspect of the invention;

FIG. 14 is a schematic of a heating circuit in accordance with a further aspect of invention;

FIG. 15 is a schematic of a heating circuit in accordance with a further aspect of the invention;

FIG. 16 is a perspective view of a device in the form of a hair-straightener, utilising the heating circuit; and

FIG. 17 is an exploded perspective view showing parts of the hair-straightener of FIG. 16.

### DETAILED DESCRIPTION

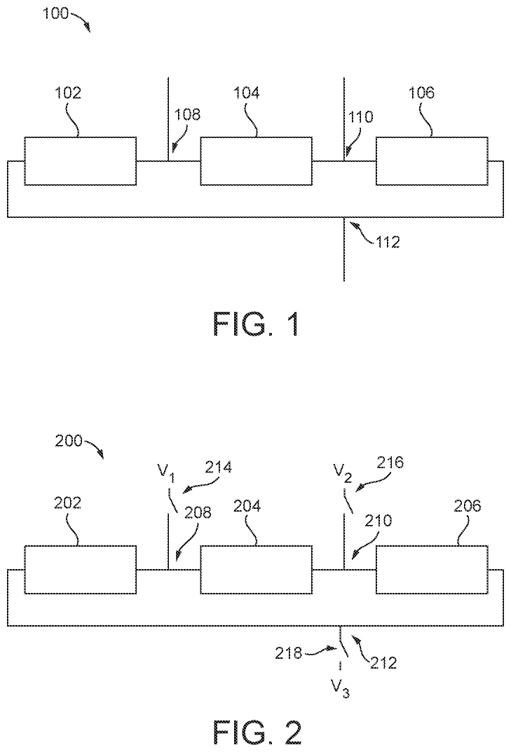

Turning to the drawings, and FIG. 1 in particular, there is provided a heating circuit 100 comprising first, second and third series-connected resistance-heating elements 102, 104, and 106.

Each resistance-heating element is connected between a pair of nodes, each pair of adjacent resistance-heating elements in the series being connected via one of the nodes. In this and all subsequently described heating circuit, each resistance-heating element may be of any suitable construction, and can comprise, for example, resistive wire or traces, optionally mounted on a former, substrate or other material. While each resistance-heating element is shown as a single element, the skilled person will appreciate that each illustrated element may take the form of two or more sub-elements, connected in parallel and/or series to give a desired output.

In heating circuit 100, resistance-heating elements 102 and 104 are connected via a first node 108, resistance-heating elements 104 and 106 are connected via a second node 110, and resistance-heating elements 106 and 102 are connected via a third node 112. Each node is connectable to a voltage, as described in more detail below.

Heating circuit 100 may installed in a device. The device may take the form of, for example, a hairstyling device, such as a hair-straightening apparatus, a hair-curling apparatus, or a hair-crimping apparatus, as described in more detail below. Alternatively, the device may take the form of any other device requiring a heating circuit, including domestic and industrial devices. Domestic devices that use heating circuits include, for example, hairdryers, fan heaters, hand-dryers, and coffee machines. Industrial devices include, for example, medical devices. These examples are non-exhaustive.

In use, voltages may selectively be applied to two or more of the nodes 108, 110, 112. The voltages may be AC or DC voltages. In addition, any suitable combination of voltages may be used. For example, two of the voltages may be the same as each other, while the other voltage may be different. Alternatively, all three of the voltages may be different to each other. Where AC is used, different relative phases may also be used, as will be understood by the skilled person.

With suitable voltages (and/or phases) applied to combinations of the resistance-heating elements, multiple parallel-resistance combinations of the resistance-heating elements may be selected. Each such combination results in, relative to at least some of the other combinations:
a different combined power output of the resistance-heating elements; and/or
a different distribution of power output across the resistance-heating elements.

Where a different combined power output of the resistance-heating elements is desired, combinations may be selected with a view to achieving a particular power output from the heating circuit as a whole. Such an arrangement may be implemented in applications where it is desirable to provide a range of different power outputs from the heating circuit. Depending upon the application for which the device is being used, the distribution of power output across the resistance-heating elements (or zones associated with the resistance-heating elements or combinations thereof) may be of less interest than the total power output.

In contrast, where a different distribution of power output across the resistance-heating elements is desired, combinations may be selected with a view to achieving particular power outputs across the various resistance-heating elements and/or zones associated with the resistance-heating elements. Such an arrangement may be implemented in applications where it is desirable to provide a range of different power outputs from the resistance-heating elements, and/or zones associated with resistance-heating elements (as described in more detail below). Depending upon the application for which the device is being used, the total power output of the heating circuit may be of less interest than the distribution of power output across the resistance-heating elements and/or zones associated with the resistance-heating elements.

While a heating circuit may comprise just the series-connected resistance-heating elements, it may also comprise one or more switching elements. Switching elements can be provided as part of the heating circuit, either connected directly to associated resistance-heating elements (e.g., on the same substrate or PCB as the resistance-heating elements, for example) or situated remotely and connected to associated resistance-heating elements by way of conductors such as wires or conductive traces. When the heating circuit is installed in a device, the switching elements may be mounted anywhere suitable within the device, such as on a circuit board, housing or other substrate.

Switching elements enable the nodes to be selectively connected to voltages as described in more detail below. The skilled person will understand that the switching elements must be controlled in order to implement the power and/or distribution control offered by the invention. Such control may be by way of a controller such as a microprocessor, analogue or digital control circuitry, or manual control of the switching elements. For clarity, many of the embodiments do not show a controller or other means of controlling the switching elements.

FIG. 2 shows a heating circuit 200 comprising first, second and third series-connected resistance-heating elements 202, 204, and 206. Each resistance-heating element is connected between a pair of nodes, each pair of adjacent resistance-heating elements in the series being connected via one of the nodes. In heating circuit 200, resistance-heating elements 202 and 204 are connected via a first node 208, resistance-heating elements 204 and 206 are connected via a second node 210, and resistance-heating elements 206 and 202 are connected via a third node 212. Each node is connectable to a voltage, as described in more detail below.

Heating circuit 200 comprises a first switching element 214, a second switching element 216 and a third switching element 218.

A first terminal of first switching element 214 is connectable to a first voltage V1, and a second terminal of first switching element 214 is connected to first node 208. First switching element 214 is switchable to enable selective connection of first node 208 to first voltage V1, as described in more detail below.

A first terminal of second switching element 216 is connectable to a second voltage V2, and a second terminal of second switching element 216 is connected to second node 210. Second switching element 216 is switchable to enable selective connection of second node 210 to second voltage V2, as described in more detail below.

A first terminal of third switching element 218 is connectable to a third voltage V3, and a second terminal of third switching element 218 is connected to third node 212. Third switching element 218 is switchable to enable selective connection of third node 212 to third voltage V3, as described in more detail below.

In use, heating circuit 200 may be installed in a device, with the first terminals of the first, second, and third switching elements 214, 216, and 218 connected respectively to first, second, and third voltages V1, V2, and V3. Depending upon the implementation, first, second, and third voltages V1, V2 and V3 may be AC or DC voltages. In addition, any suitable combination of voltages may be used. For example, two of the voltages (e.g., V1 and V2) may be the same as each other, while the other voltage (e.g., V3) may be different. Alternatively, all three of the voltages may be different to each other. Where AC is used, different relative phases may also be used, as will be understood by the skilled person.

With suitable selection of voltages (and/or phases) and switching combinations, multiple parallel-resistance combinations of the resistance-heating elements may be selected. Each such combination results in, relative to at least some of the other combinations:
a different combined power output of the resistance-heating elements; and/or
a different distribution of power output across the resistance-heating elements.

Where a different combined power output of the resistance-heating elements is desired, combinations may be selected with a view to achieving a particular power output from the heating circuit as a whole. Such an arrangement may be implemented in applications where it is desirable to provide a range of different power outputs from the heating circuit. Depending upon the application for which the device is being used, the distribution of power output across the resistance-heating elements (or zones associated with the resistance-heating elements or combinations thereof) may be of less interest than the total power output.

In contrast, where a different distribution of power output across the resistance-heating elements is desired, combinations may be selected with a view to achieving particular power outputs across the various resistance-heating elements and/or zones associated with the resistance-heating elements. Such an arrangement may be implemented in applications where it is desirable to provide a range of different power outputs from the resistance-heating elements, and/or zones associated with resistance-heating elements (as described in more detail below). Depending upon the application for which the device is being used, the total power output of the heating circuit may be of less interest than the distribution of power output across the resistance-heating elements and/or zones associated with the resistance-heating elements.

For example, with reference to heating circuit 200 of FIGS. 2, V1 and V2 may be 12V and V3 may be 0V. Closing first switching element 214 and third switching element 218 while leaving second switching element 216 open causes current to flow through first switching element 214, where it splits into a first current that passes through first resistance-heating element 202, and a second current that passes through second resistance-heating element 204 and third resistance-heating element 206. The sum of the first current and the second current then passes through closed third switching element 218. In effect, closing first switching element 214 and third switching element 218 while leaving second switching element 216 open provides a resistance combination comprising first resistance-heating element 202 in parallel with the series combination of second resistance-heating element 204 and third resistance-heating element 206.

Alternatively, closing second switching element 216 and third switching element 218 while leaving first switching element 214 open causes current to flow through second switching element 216, where it splits into a first current that passes through second resistance-heating element 204 and first resistance-heating element 202, and a second current that passes through third resistance-heating element 206. The sum of the first current and the second current then passes through the closed third switching element 218. In effect, closing second switching element 216 and third switching element 218 while leaving first switching element 214 open provides a resistance combination comprising third resistance-heating element 206 in parallel with the series combination of second resistance-heating element 204 and first resistance-heating element 202.

It will be appreciated that, if first resistance-heating element 202, second resistance-heating element 204, and third resistance-heating element 206 have the same power rating, heating circuit 200 has the same power output irrespective of whether:
first switching element 214 and third switching element 218 are closed while second switching element 216 is held open; or
second switching element 216 and third switching element 218 are closed while first switching element 208 is held open.

However, even though the total power output by heating circuit 200 is the same in both scenarios, the distribution of power across the resistance-heating elements 202, 204 and 206 is different. In each case, less current flows through the series pair of adjacent resistance-heating elements than through the single resistance-heating element with which they are paralleled. This allows for different power outputs per resistance-heating element (or combination thereof). This difference may be used to differentially heat zones of a device within which heating circuit 200 is installed.

It will be appreciated that the heating circuits of FIGS. 1 and 2 each take the form of a series-connected ring circuit. This is because every resistance-heating element is connected in series with two adjacent resistance-heating elements, to form a ring circuit.

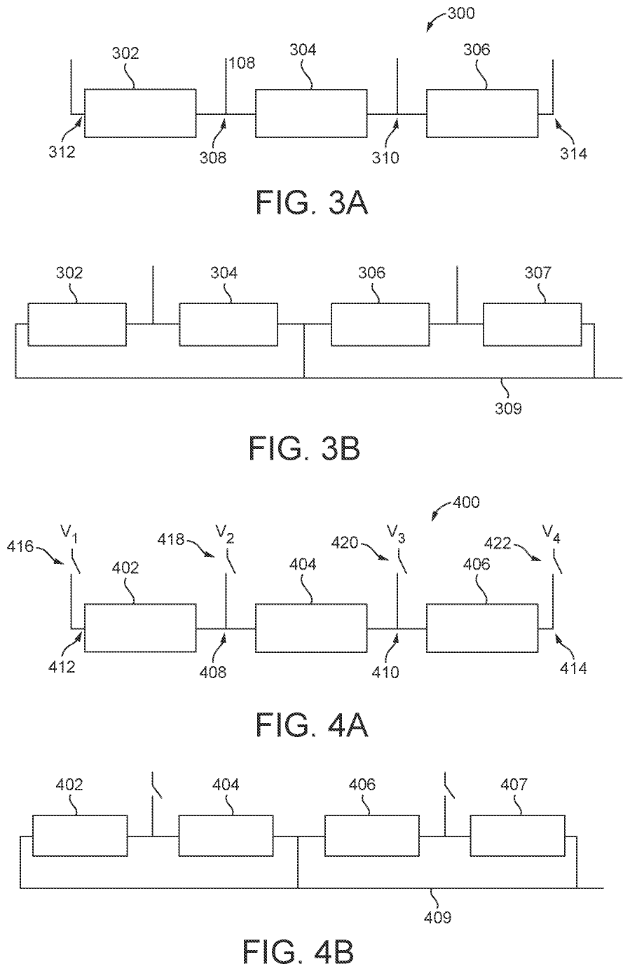

Turning to FIG. 3a, there is shown an alternative heating circuit 300. comprising first, second and third series-connected resistance-heating elements 302, 304, and 306.

Each resistance-heating element is connected between a pair of nodes, each pair of adjacent resistance-heating elements in the series being connected via one of the nodes. In heating circuit 300, resistance-heating elements 302 and 304 are connected via a first node 308 and resistance-heating elements 304 and 306 are connected via a second node 310. In contrast with heating circuits 100 and 200 of FIGS. 1 and 2, resistance-heating elements 306 and 302 of heating circuit 300 are not directly connected via a further node. Instead, a side of resistance-heating element 302 not connected to first node 308 is connected to an independent third node 312, and a side of resistance-heating element 306 not connected to second node 310 is connected to an independent fourth node 314. Each node is connectable to a voltage, as described in more detail below.

FIG. 3b illustrates an alternative heating circuit 301, comprising first, second, third and fourth series-connected resistance-heating elements 302, 304, 306 and 307. Similarly to FIG. 3a, each resistance-heating element is connected between a pair of nodes, each pair of adjacent resistance-heating elements in the series being connected via one of the nodes, and a common plane 309.

As with heating circuit 100, heating circuit 300 of FIGS. 3a and 3b may be installed in a device. The device may take the form of, for example, a hairstyling device, such as a hair-straightening apparatus, a hair-curling apparatus, or a hair-crimping apparatus, as described in more detail below. Alternatively, the device may take the form of any other device requiring a heating circuit, such as, for example, any of the domestic and industrial devices mentioned above.

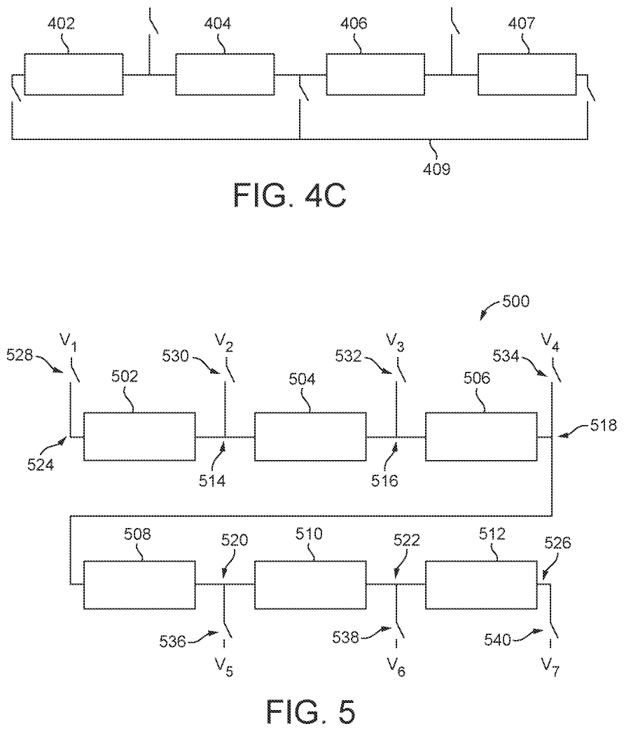

As explained above, the heating circuit may comprise switching elements connected to the respective nodes, to enable the nodes to be selectively connected to voltages as described in more detail below. For example, FIG. 4a shows a heating circuit 400 comprising first, second and third series-connected resistance-heating elements 402, 404, and 406.

Each resistance-heating element is connected between a pair of nodes, each pair of adjacent resistance-heating elements in the series being connected via one of the nodes. In heating circuit 400 of FIG. 4a, resistance-heating elements 402 and 404 are connected via a first node 408 and resistance-heating elements 404 and 406 are connected via a second node 410. In contrast with heating circuits 100 and 200 of FIGS. 1 and 2, resistance-heating elements 406 and 402 are not directly connected via a further node. Instead, a side of resistance-heating element 402 not connected to first node 408 is connected to an independent third node 412, and a side of resistance-heating element 406 not connected to second node 410 is connected to an independent fourth node 414. Each node is connectable to a voltage, as described in more detail below.

Heating circuit 400 comprises a first switching element 416, a second switching element 418, a third switching element 420, and a fourth switching element 422.

A first terminal of first switching element 416 is connectable to a first voltage V1, and a second terminal of first switching element 416 is connected to third node 412. First switching element 416 is switchable to enable selective connection of third node 412 to first voltage V1, as described in more detail below.

A first terminal of second switching element 418 is connectable to a second voltage V2, and a second terminal of second switching element 418 is connected to first node 408. Second switching element 418 is switchable to enable selective connection of first node 408 to second voltage V2, as described in more detail below.

A first terminal of third switching element 420 is connectable to a third voltage V3, and a second terminal of third switching element 420 is connected to second node 410. Third switching element 420 is switchable to enable selective connection of second node 410 to third voltage V3, as described in more detail below.

A first terminal of fourth switching element 422 is connectable to a fourth voltage V4, and a second terminal of fourth switching element 422 is connected to fourth node 414. Fourth switching element 422 is switchable to enable selective connection of fourth node 414 to fourth voltage V4, as described in more detail below.

Heating circuit 400 may be installed in a device, and the first terminals of first, second, third, and fourth switching elements 416, 418, 420, and 422 are connected respectively to first, second, third, and fourth voltages V1, V2, V3, and V4. Depending upon the implementation, first, second, third and fourth voltages V1, V2, V3, and V4 may be AC or DC voltages. In addition, any suitable combination of voltages may be used. For example, two or three of the voltages (e.g., V1 and V2, or V1, V2 and V3) may be the same as each other, while the other voltage(s) (e.g., V3 and V4, or V4) may be different. Alternatively, any sub-combination of the voltages may be different to each other. Where AC is used, different relative phases may also be used, as will be understood by the skilled person.

As with heating circuit 200 of FIG. 2, with suitable selection of voltages (and/or phases) and switching combinations, multiple parallel-resistance combinations of the resistance-heating elements of FIG. 4a may be selected. Each such combination results in, relative to at least some of the other combinations:
a different combined power output of the resistance-heating elements; and/or
a different distribution of power output across the resistance-heating elements.

For example, with reference to heating circuit 400 of FIG. 4a, V1 and V3 may be 12V, and V2 and V4 may be 0V. Closing first switching element 416, second switching element 418, and third switching element 420 while leaving fourth switching element 422 open causes a first current to flojw through first switching element 416 and first resistance-heating element 402 to first node 408, and a second current to flow through third switching element 420 and second resistance-heating element 404 to first node 408. The sum of the first current and the second current then passes through the closed second switching element 418. In essence, closing first switching element 416, second switching element 418 and third switching element 420 while leaving fourth switching element 422 open provides a resistance combination comprising first resistance-heating element 402 in parallel with second resistance-heating element 404.

Alternatively, second switching element 418, third switching element 420, and fourth switching element 422 can be closed while first switching element 416 is left open. Current flows through third switching element 420, and splits into a first current that flows through second node 410, second resistance-heating element 404 and second switching element 418, and a second current that flows through second node 410, third resistance-heating element 406 and fourth switching element 422. In essence, closing second switching element 418, third switching element 420 and fourth switching element 422 while leaving first switching element 416 open provides a resistance combination comprising second resistance-heating element 404 in parallel with third resistance-heating element 406.

The skilled person will appreciate that, if first resistance-heating element 402, second resistance-heating element 404, and third resistance-heating element 406 have the same power rating (for a given applied voltage), heating circuit 400 has the same power output irrespective of whether:
first switching element 416, second switching element 418, and third switching element 420 are closed while fourth switching element 422 is held open; or
second switching element 418, third switching element 420, and fourth switching element 422 are closed while first switching element 418 is held open.

However, even though the total power output by heating circuit 400 is the same in both scenarios, the distribution of power across the resistance-heating elements 402, 404 and 406 is different. This difference may be used to differentially heat zones of a device within which heating circuit 400 is installed.

In contrast with the heating circuits of FIGS. 1 and 2, the heating circuits of FIGS. 3a and 4a are not ring circuits. While resistance-heating elements 304 and 404 are each connected to adjacent resistance-heating elements, resistance-heating elements 302, 306, 402 and 406 are only connected to one other resistance-heating element.

FIG. 4b shows an alternative heating circuit 401 comprising first, second, third and fourth series-connected resistance-heating elements 402, 404, 406 and 407. Similarly to FIG. 4a, each resistance-heating element is connected between a pair of nodes, each pair of adjacent resistance-heating elements in the series being connected via one of the nodes, and a common plane 409.

FIG. 4c is a schematic diagram of heating circuit in accordance with a further aspect of the invention. Although similar to FIG. 4b, three additional switching elements are provided, each located between a resistance-heating element and a common plane 409.

While FIGS. 1 to 4c each show three or four resistance-heating elements, it will be appreciated that additional series-connected resistance-heating elements may be provided. This may enable, for example, a wider range of power outputs and/or distributions of power across the resistance-heating elements.

For example, FIG. 5 shows a heating circuit 500 comprising first, second, third, fourth, fifth and sixth series-connected resistance-heating elements 502, 504, 506, 508, 510, and 512.

Each resistance-heating element is connected between a pair of nodes, each pair of adjacent resistance-heating elements in the series being connected via one of the nodes. In heating circuit 500 of FIG. 5, resistance-heating elements 502 and 504 are connected via a first node 514, resistance-heating elements 504 and 506 are connected via a second node 516, resistance-heating elements 506 and 508 are connected via a third node 518, resistance-heating elements 508 and 510 are connected via a fourth node 520, and resistance-heating elements 510 and 512 are connected via a fifth node 522.

Resistance-heating elements 512 and 502 are not directly connected to another resistance-heating element. Instead, a side of resistance-heating element 502 not connected to first node 514 is connected to an independent sixth node 524, and a side of resistance-heating element 512 not connected to fifth node 522 is connected to an independent seventh node 526. Each node is connectable to a voltage, as described in more detail below.

Heating circuit 500 comprises a first switching element 528, a second switching element 530, a third switching element 532, a fourth switching element 534, a fifth switching element 536, a sixth switching element 538, and a seventh switching element 540.

A first terminal of first switching element 528 is connectable to a first voltage V1, and a second terminal of first switching element 528 is connected to sixth node 524.

A first terminal of second switching element 530 is connectable to a second voltage V2, and a second terminal of second switching element 530 is connected to first node 514.

A first terminal of third switching element 532 is connectable to a third voltage V3, and a second terminal of third switching element 532 is connected to second node 516.

A first terminal of fourth switching element 534 is connectable to a fourth voltage V4, and a second terminal of fourth switching element 534 is connected to third node 518.

A first terminal of fifth switching element 536 is connectable to a fifth voltage V5, and a second terminal of fifth switching element 536 is connected to fourth node 520.

A first terminal of sixth switching element 538 is connectable to a sixth voltage V6, and a second terminal of sixth switching element 538 is connected to fifth node 522.

A first terminal of seventh switching element 540 is connected to a seventh voltage V7, and a second terminal of seventh switching element 540 is connected to seventh node 526.

Each of switching elements 528, 530, 532, 534, 536, 538, and 540 is switchable to enable selective connection of its corresponding voltage V1, V2, V3, V4, V5, V6, and V7 to its corresponding node, in a similar manner to as was described in relation to heating circuit 400.

Heating circuit 500 may be installed in a device, and the first terminals of the switching elements 528, 530, 532, 534, 536, 538, and 540 are connected respectively to voltages V1, V2, V3, V4, V5, V6, and V7. Depending upon the implementation, the voltages may be AC or DC voltages. In addition, any suitable combination of voltages may be used. For example, two or more of the voltages may be the same as each other, while other voltages may be different.

Alternatively, any sub-combination of the voltages may be different to each other. Where AC is used, different relative phases may also be used, as will be understood by the skilled person.

With suitable selection of voltages (and/or phases) and switching combinations, multiple parallel-resistance combinations of the resistance-heating elements of FIG. 5 may be selected. Each such combination results in, relative to at least some of the other combinations:
a different combined power output of the resistance-heating elements; and/or
a different distribution of power output across the resistance-heating elements.

It will be appreciated that the greater number of resistance-heating elements in heating circuit 500 (compared to heating circuits 100, 200, 300 and 400) provides for a potentially greater number of different combined power outputs of the resistant resistance-heating elements, and/or a greater number of different distributions of power output across the resistance-heating elements and/or associated zones.

Although heating circuit 500 has six resistance-heating elements, the skilled person will appreciate that any suitable number of resistance-heating elements may be selected to suit the requirements of a particular application.

Although heating circuit 500 shows a switching element connected to each and every node, it will be appreciated that a heating circuit of the type illustrated in FIG. 5 may take the form of a component assembly that does not comprise any switching elements, or at least does not comprise switching elements for every node. One or more nodes may be connected, in use, directly to the required voltage. Similarly, one or more nodes may be connected, in use, to the required voltage via corresponding switching elements.

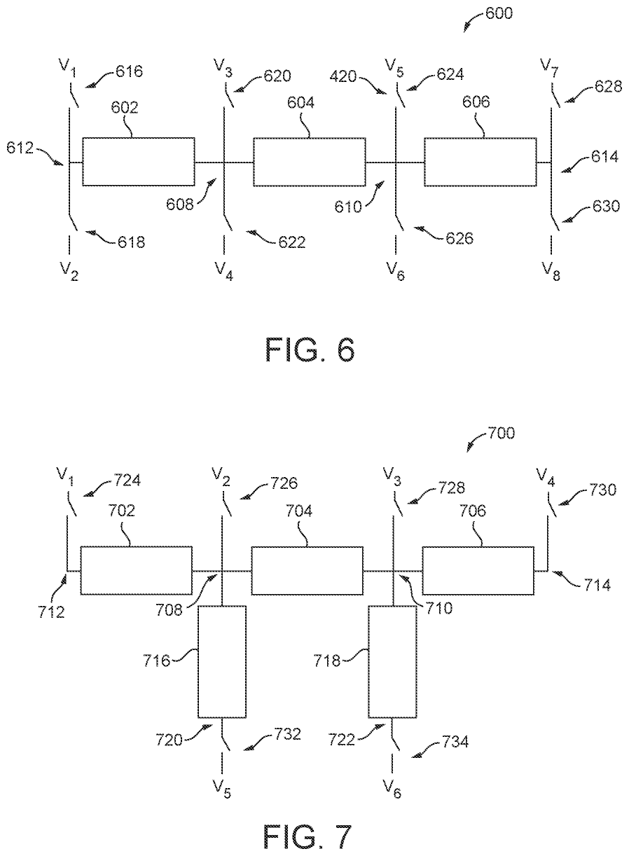

While the heating circuits of FIGS. 1-5 show connections (or potential connections via switching elements) to only a single voltage at each node, other heating circuits can be configured to allow more than one voltage to selectively be connected to one or more of the nodes. For example, FIG. 6 shows a heating circuit 600 comprising first, second and third series-connected resistance-heating elements 602, 604, and 606. Each resistance-heating element is connected between a pair of nodes, each pair of adjacent resistance-heating elements in the series being connected via one of the nodes.

In heating circuit 600, resistance-heating elements 602 and 604 are connected via a first node 608 and resistance-heating elements 604 and 606 are connected via a second node 610. Resistance-heating elements 606 and 602 are not directly connected via a further node. Instead, a side of resistance-heating element 602 not connected to first node 608 is connected to an independent third node 612, and a side of resistance-heating element 606 not connected to second node 610 is connected to an independent fourth node 614. Each node is connectable to one or more voltages, as described in more detail below.

Heating circuit 600 comprises switching elements connected to the respective nodes, to enable the nodes to be selectively connected to one or more voltages as described in more detail below. In particular, heating circuit 600 comprises a first switching element 616, a second switching element 618, a third switching element 620, a fourth switching element 622, a fifth switching element 624, a sixth switching element 626, a seventh switching element 628, and an eighth switching element 630.

A first terminal of first switching element 616 is connectable to a first voltage V1 and a first terminal of second switching element 618 is connectable to a second voltage V2. A second terminal of first switching element 616 and a second terminal of second switching element 618 are connected to third node 612.

A first terminal of third switching element 620 is connectable to a third voltage V3 and a first terminal of fourth switching element 622 is connectable to a fourth voltage V4. A second terminal of third switching element 620 and a second terminal of fourth switching element 622 are connected to first node 608.

A first terminal of fifth switching element 624 is connectable to a fifth voltage V5 and a first terminal of sixth switching element 626 is connectable to a sixth voltage V6. A second terminal of fifth switching element 624 and a second terminal of sixth switching element 626 are connected to second node 610.

A first terminal of seventh switching element 628 is connectable to a seventh voltage V7 and a first terminal of eighth switching element 630 is connectable to an eighth voltage V8. A second terminal of seventh switching element 628 and a second terminal of eighth switching element 630 are connected to fourth node 614.

Heating circuit 600 may be installed in a device (for example, a hairstyling device, such as a hair-straightening apparatus, a hair-curling apparatus, or a hair-crimping apparatus), and the first terminals of first, second, third, fourth, fifth, sixth, seventh, and eighth switching elements 616, 618, 620, 622, 624, 626, 628, 630 are connected respectively to first, second, third, fourth, fifth, sixth, seventh, and eighth voltages V1, V2, V3, V4, V5, V6, V7, and V8. Depending upon the implementation, first, second, third, fourth, fifth, sixth, seventh, and eighth voltages V1, V2, V3, V4, V5, V6, V7, and V8 may be AC or DC voltages. In addition, any suitable combination of voltages may be used. For example, any two or more of the voltages may be the same as each other, while the other voltage(s) may be different. Alternatively, any sub-combination of the voltages may be different to each other. Where AC is used, different relative phases may also be used, as will be understood by the skilled person.

It will be understood by the skilled person that it may be less useful to have two different sources of the same voltages (and/or phases, for AC) connectable to the same node. For example, in a DC application, V1 may be different to V2, V3 may be different to V4, V5 may be different to V6, and V7 may be different to V8. Similar comments apply to phases where AC power is used.

With suitable selection of voltages (and/or phases) and switching combinations, multiple parallel-resistance combinations of the resistance-heating elements of FIG. 6 may be selected. Each such combination results in, relative to at least some of the other combinations:
a different combined power output of the resistance-heating elements; and/or
a different distribution of power output across the resistance-heating elements and/or associated zones.

In contrast with heating circuits 200 and 400, for example, heating circuit 600 enables connection of different voltages to each of at least some of the nodes. This increases the number of combinations of power output and/or distribution of power output across the resistance-heating elements, as will be described in more detail below in relation to other heating circuits.

In the heating circuits of FIGS. 1-6, all of the resistance-heating elements in each heating circuit are series-connected. The skilled person will appreciate that one or more additional resistance-heating elements may be provided that are not connected in that series. For example, FIG. 7 shows a heating circuit 700 comprising first, second, and third series-connected resistance-heating elements 702, 704, and 706. Each resistance-heating element is connected between a pair of nodes.

In heating circuit 700, resistance-heating elements 702 and 704 are connected via a first node 708 and resistance-heating elements 704 and 706 are connected via a second node 710. Resistance-heating elements 706 and 702 are not directly connected via a further node. Instead a side of resistance-heating element 702 not connected to first node 708 is connected to an independent third node 712, and a side of resistance-heating element 706 not connected to second node 710 is connected to an independent fourth node 714.

Heating circuit 700 includes a first additional resistance-heating element 716 and a second additional resistance-heating element 718. A first side of first additional resistance-heating element 716 is connected to first node 708 and a first side of second additional resistance-heating element 718 is connected to second node 710. A second side of first additional resistance-heating element 716 is connected to a fifth independent node 720 and a second side of second additional resistance-heating element 718 is connected to a sixth independent node 722.

It will be noted that the first and second additional resistance-heating elements 716 and 718 are not part of the series-connected circuit comprising resistance-heating elements 702, 704 and 706.

Heating circuit 700 comprises switching elements connected to the respective nodes, to enable the nodes to be selectively connected to one or more voltages as described in more detail below. In particular, heating circuit 700 comprises a first switching element 724, a second switching element 726, a third switching element 728, a fourth switching element 730, a fifth switching element 732, and a sixth switching element 734.

A first terminal of first switching element 724 is connectable to a first voltage V1, and a second terminal of first switching element 724 is connected to third node 712.

A first terminal of second switching element 726 is connectable to a second voltage V2 and a second terminal of second switching element 726 is connected to first node 708.

A first terminal of third switching element 728 is connectable to a third voltage V3 and a second terminal of third switching element 728 is connected to second node 710.

A first terminal of fourth switching element 730 is connectable to a fourth voltage V4, and a second terminal of fourth switching element is connected to fourth node 714.

A first terminal of fifth switching element 732 is connectable to a fifth voltage V5, and a second terminal of fifth switching element 732 is connected to fifth node 720.

A first terminal of sixth switching element 734 is connectable to a sixth voltage V6, and a second terminal of sixth switching element 734 is connected to sixth node 722.

Heating circuit 700 may be installed in a device (for example, a hairstyling device, such as a hair-straightening apparatus, a hair-curling apparatus, or a hair-crimping apparatus), and the first terminals of first, second, third, fourth, fifth and sixth switching elements 724, 726, 728, 730, 732 and 734 are connected respectively to first, second, third, fourth, fifth and sixth voltages V1, V2, V3, V4, V5 and V6. Depending upon the implementation, first, second, third, fourth, fifth and sixth voltages V1, V2, V3, V4, V5 and V6 may be AC or DC voltages. In addition, any suitable combination of voltages may be used. For example, any two or more of the voltages may be the same as each other, while the other voltage(s) may be different. Alternatively, any sub-combination of the voltages may be different to each other. Where AC is used, different relative phases may also be used, as will be understood by the skilled person.

With suitable selection of voltages (and/or phases) and switching combinations, multiple parallel-resistance combinations of the resistance-heating elements of FIG. 7 may be selected. Each such combination results in, relative to at least some of the other combinations:
a different combined power output of the resistance-heating elements; and/or
a different distribution of power output across the resistance-heating elements and/or associated zones.

For example, with reference to heating circuit 700 of FIG. 7, voltages V1, V2, V3 and V4 may be 12V DC and voltages V5 and V6 may be 0V DC. Closing first switching element 724, fifth switching element 732 and sixth switching element 734 while leaving second switching element 726, third switching element 728 and fourth switching element 730 open causes a first current to flow through first switching element 724 and first resistance-heating element 702 to first node 708, and a second current to flow through second switching element 726 to first node 708. The first and second currents combine at first node 708 and then split into third and fourth currents. The third current flows through the first additional resistance-heating element 716, fifth node 720 and fifth switching element 732, and the fourth current flows through second resistance-heating element 704, second additional resistance-heating element 718, sixth node 722 and sixth switching element 734. In essence, closing first switching element 724, fifth switching element 732 and sixth switching element 734 provide a resistance combination comprising first resistance-heating element 702 in series with a parallel combination consisting of a first additional resistance-heating element 716 in parallel with a series combination of second additional resistance-heating element 718 and third additional resistance-heating element 719.

The skilled person will appreciate that one or more additional resistance-heating elements not forming part of the series-connected resistance-heating elements may be connected to any one or more of the nodes of a heating circuit. The skilled person will also appreciate that although FIG. 7 shows a non-ring-connected heating circuit, one or more additional resistance-heating elements may also be used for ring-connecting heating circuits.

The described heating circuits may be installed in a device. The device may be a personal care device, such as a hairstyling device. Examples of a hairstyling device include hair-straighteners, a hair-curling wands and tongs, and hair-crimpers (and devices incorporating the functionality of two or more of such devices. The device may alternatively be a heating device, such as, for example, any of the domestic and industrial devices mentioned above. Further, the described heating circuits may be installed as an auxiliary heater to maintain the correct operational temperature of, for example, electronics and batteries in a device such as satellites, spacecraft, aircraft or electric vehicles.

Optionally, a device within which a heating circuit is installed may comprise a heating surface having a plurality of heating zones, each of the zones being heatable by at least one of the resistance-heating elements. Drive circuitry is configured to selectively drive combinations of the nodes with voltages, such that different combinations of voltages connected to at least two of the nodes at a time allow selection of respective corresponding parallel-resistance combinations of the resistance-heating elements as described above.

Heating zones can, for example, extend in a linear direction along a portion of the device. That is, the position of individual zones may be spaced along the length of a portion of the device. For example, and as shown in more detail below, individual heating zones may extend along the length of a hair-straightener.

The device may also, for example, comprise an array of heating zones, where each resistance-heating element is arranged to heat at least one of the heating zones. For example, each resistance-heating element can be arranged such that, when it is driven by a drive current, the resistance-heating element heats just that zone. Alternatively, or in addition, two or more resistance-heating elements may overlap such that more than one resistance-heating element may contribute to the heating of a zone. Alternatively, or in addition, one or more of the resistance-heating elements may be arranged such that it contributes to heating of two or more zones.

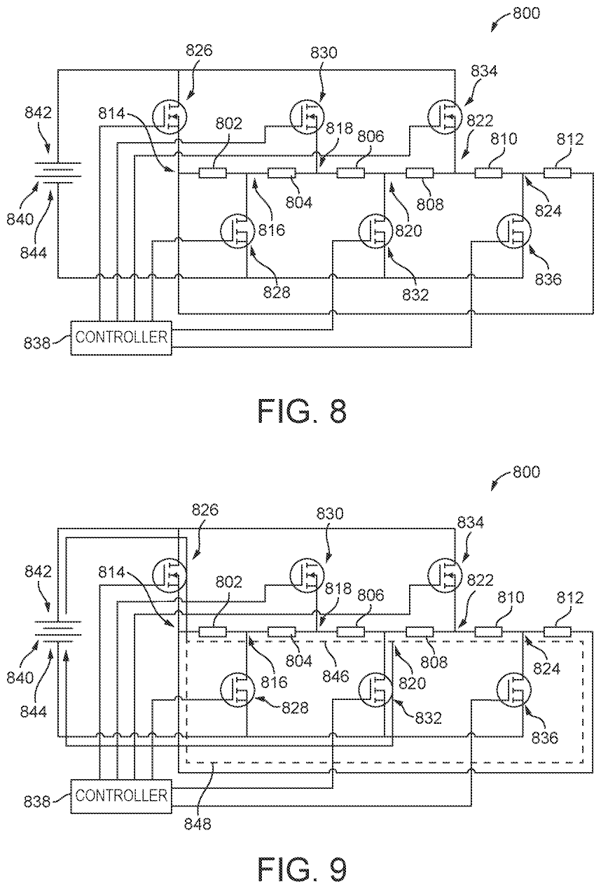

Turning to FIGS. 8-12 the operation of a specific heating circuit 800 will be described in detail. Heating circuit 800 is installed in a device, such as a hair-styling device, and comprises first, second, third, fourth, fifth and sixth series-connected resistance-heating elements 802, 804, 806, 808, 810, and 812.

Each resistance-heating element is connected between a pair of nodes, each pair of adjacent resistance-heating elements in the series being connected via one of the nodes. In heating circuit 800, resistance-heating elements 802 and 812 are connected via a first node 814, resistance-heating elements 802 and 804 are connected via a second node 816, resistance-heating elements 804 and 806 are connected via a third node 818, resistance-heating elements 806 and 808 are connected via a fourth node 820, resistance-heating elements 808 and 810 are connected via a fifth node 822, and resistance-heating elements 810 and 812 are connected via a sixth node 824.

Heating circuit 800 also comprises a power source in the form of a battery 840 having a positive terminal 842 and a negative terminal 844. Battery 840 is a rechargeable 14.4V lithium-ion battery, but any other suitable power supply may be used. Alternatives include, for example, batteries using a different chemistry or voltage, capacitors, AC/DC converters, any other type of DC power supply, or a combination thereof.

Heating circuit 800 comprises a first switching element 826, a second switching element 828, a third switching element 830, a fourth switching element 832, a fifth switching element 834, and a sixth switching element 836. Each switching element takes the form of a MOSFET in heating circuit 800, but may alternatively take the form of any other current control device suitable for a particular installation, such as a relay, bipolar junction transistor, silicon controlled rectifier, or different type of field effect transistor.

Respective first terminals of first switching element 826, third switching element 830 and fifth switching element 834 are connected to positive terminal 842, and respective first terminals of second switching element, 828, fourth switching element 832 and sixth element 836 are connected to negative terminal 844.

Second terminals of first switching element 826, second switching element 828, third switching element 830, fourth switching element 832, fifth switching element 834 and sixth switching terminal 836 are connected to first node 814, second node 816, third node 818, fourth node 820, fifth node 822 and sixth node 824, respectively.

A gate of each switching element is connected to a controller 838. Controller 838 may take the form of, for example; a programmable microcontroller, an application specific integrated circuit (ASIC), or a programmable logic device, with independently controllable outputs capable of driving the MOSFET gates directly, or via a specific MOSFET gate drive circuit, as will be understood by the skilled person.

In use, controller 838 controls a voltage at the gate of each of switching elements 826, 828, 830, 832, 834 and 836. When a switching element is turned “on” by controller 838, current flows through the switching element, dependent upon which other switching elements are also turned on at the same time.

Using 6-bit binary pattern combinations as a model for the control signals applied to the gate (i.e., one bit per gate equating to an “on” or “off” signal), there are 2⁶ (64) combinations of “on” and “off” values across all switching elements. Removing combinations with no current flow, all off and combinations with the just upper or lower switches activated, results in 51 possible active combinations. Individual combinations can be selected to control the individual resistance heating elements, and hence the heating circuit as a whole. For example, to heat the whole heating area of the device quickly, all the switches can be turned on (assuming maximum battery current is not exceeded).

The skilled person will appreciate that it may not always be possible to perfectly control every resistance heating element. However, the only way to achieve such control is to provide each individual resistance-heating element with direct control. Unless individual resistance heating element modulation is provided, direct control of individual resistance-heating elements does not offer the range of different heating combinations and profiles offered by the described heating circuits.

One way of improving control of the heating circuit as a whole is to time-slice between different operating modes. By controlling the order of such operating modes, and the time for which each operating mode is held, the contributions of the operating modes will be integrated as the sequence is applied, which may provide a desired heating output and/or distribution over time. Examples of specific operating modes of heating circuit 800 will be described with reference to FIGS. 9 to 12.

In FIG. 9, first switching element 826 and fourth switching element 832 are controlled by controller 838 to be “on”. Current flows from the positive terminal 842, through first switching element 826 and to first node 814. From first node 814, there are two paths the current can take on the way back to negative terminal 844. The first path, shown by solid line 846 between first node 814 and fourth node 820, passes through the first, second and third resistance-heating elements 802, 804 and 806. The second path, shown by dotted line 848 between first node 814 and fourth node 820, passes through the sixth, fifth and fourth nodes 812, 810 and 808. The sum of the currents through the first and second paths then passes through fourth switching element 832, and then to the negative terminal 844.

In the operating mode of FIG. 9, and viewed from battery 840, the series resistance of the first, second and third resistance-heating elements 802, 804 and 806 is in parallel with the series resistance of the sixth, fifth and fourth resistance-heating elements 812, 810 and 808. The net result is that all resistance-heating elements are at the same temperature.

Using an example of a 12.6V battery and each resistance-heating element being 10 ohms, the battery in the FIG. 9 operating mode sees a resistance of 15 ohms. This gives a total power output (given by P=V²/R) across all resistance-heating elements of 10 W. As such, this mode may be considered a low power, even-distribution mode.

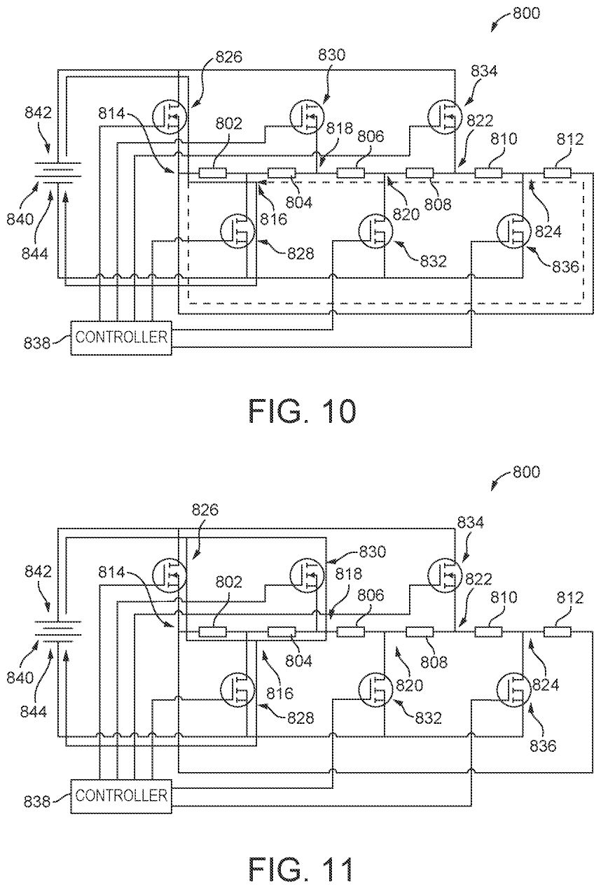

In FIG. 10, first switching element 826 and second switching element 828 are controlled by controller 838 to be “on”. Current flows from the positive terminal 842, through first switching element 826 and to first node 814. From first node 814, there are 2 paths the current can take on the way back to negative terminal 844. The first path, shown by solid line 850 between first node 814 and second node 816, passes through first resistance-heating element 802. The second path, shown by dotted line 852 between first node 814 and second node 816, passes through the sixth, fifth, fourth, third, and second nodes 812, 810, 808, 806 and 804. The sum of the currents through the first and second paths then passes through second switching element 828, and then to the negative terminal 844.

In the operating mode of FIG. 10, and viewed from battery 840, the resistance of first resistance-heating element 802 is in parallel with the series resistance of the sixth, fifth, fourth, third and second resistance-heating elements 812, 810, 808, 806 and 804. The net result is that the first, second, third, fourth and fifth resistance-heating elements 804, 806, 808, 810 and 812 are all at the same temperature. However, because they pass considerably less current than first resistance-heating element 806, each of the first, second, third, fourth and fifth resistance-heating elements 804, 806, 808, 810 and 812 outputs less heat than first resistance-heating element 806.

Using an example of a 12.6V battery and each resistance-heating element being 10 ohms, the battery in the FIG. 10 operating mode sees a resistance of 6.6 ohms. The full supply voltage is applied to first resistance-heating element 802 and a fifth of the supply voltage is seen across each of the other resistance-heating elements. As such, this may be considered a focused heating mode, in which first resistance-heating element 802 is heated relatively strongly compared to the remaining resistance-heating elements.

In FIG. 11, first switching element 826, second switching element 828 and third switching element 830 are controlled by controller 838 to be “on”. Current flows from positive terminal 842 through first switching element 826 to first node 814 and through third switching element 830 to third node 818. Current arriving at first node 814 flows through first resistance-heating element 802 to second node 816 and current arriving at third node 818 flows through second resistance-heating element 804 to second node 816. The sum of the current arriving at second node 816 then passes through second switching element 828 before returning to negative terminal 844.

In the operating mode of FIG. 11, and viewed from battery 840, the resistance of first resistance-heating element 802 is in parallel with the resistance of the second resistance-heating element, while the third, fourth, fifth and sixth resistance-heating elements are turned off. The net result is that the first and second resistance-heating elements are at the same temperature while the remaining resistance-heating elements remain cool (other than residual temperature if they were driven previously).

Using an example of a 12.6V battery and each resistance-heating element being 10 ohms, the battery in the FIG. 11 operating mode sees a resistance of 5 ohms. The full supply voltage is applied to both first resistance-heating element 802 and second resistance-heating element 804. As such, this may be considered a focused heating mode, in which first resistance-heating element 802 are second resistance-heating element 804 are heated relatively strongly while the remaining resistance-heating elements are switched off. As such, this may be considered another type of focused heating mode, but one in which several resistance-heating elements are not heated.

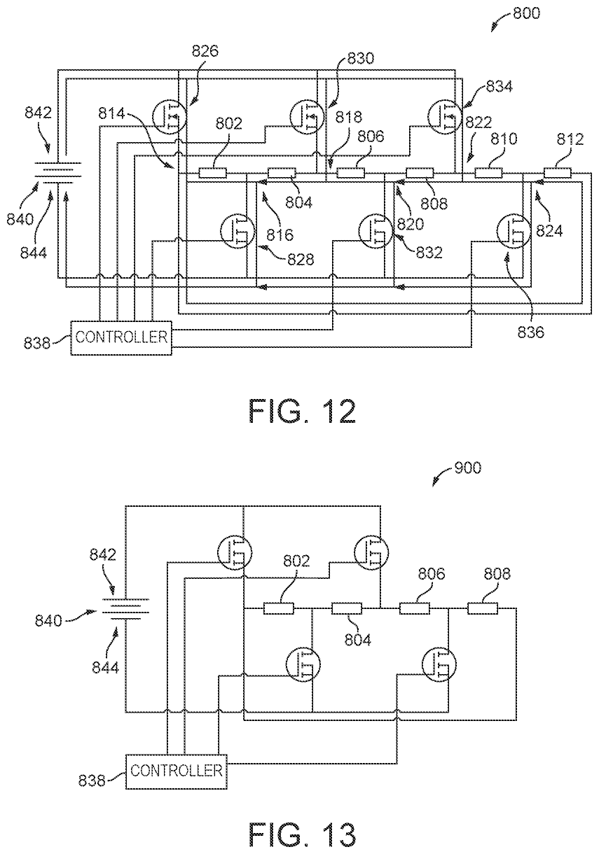

In FIG. 12, first switching element 826, second switching element 828, third switching element 830, fourth switching element 832, fifth switching element 834 and sixth switching element 836 are controlled by controller 838 to be “on”. Current flows from positive terminal 842 and is then split such that a portion flows through first switching element 826 to first node 814, a portion flows through third switching element 830 to third node 818 and a portion flows through fifth switching element 834 to fifth node 822.

Current arriving at first node 814 from first switching element 826 is split such that a portion flows through first resistance-heating element 802 to second node 816 and a portion flows through sixth resistance-heating element 812 to sixth node 824.

Current arriving at third node 818 from third switching element 830 is split such that a portion flows through second resistance-heating element 804 to second node 816 and a portion flows through third resistance-heating element 806 to fourth node 820.

Current arriving at fifth node 822 from fifth switching element 834 is split such that a portion flows through fourth resistance-heating element 808 to fourth node 820 and a portion flows through fifth resistance-heating element 810 to sixth node 824.

The sum of the currents arriving at second node 816 passes through second switching element 828, the sum of the currents arriving at fourth node 820 passes through fourth switching element 832 and the sum of the currents arriving at sixth node 824 passes through sixth switching element 836. The sum of the currents leaving second switching element 828, fourth switching element 832 and sixth switching element 836 then return to negative terminal 844.

In the operating mode of FIG. 12, and viewed from battery 840, there are three resistances in parallel: first resistance-heating element 802 in parallel with sixth resistance-heating element 812; second resistance-heating element 804 in parallel with third resistance-heating element 806; and fourth resistance-heating element 808 in parallel with fifth resistance-heating element 810. The net result is that all resistance-heating elements are at the same temperature, although because currents are higher, this temperature is higher than the temperature of the resistance-heating elements in the operating mode of FIG. 9.

Using an example of a 12.6V battery and each resistance-heating element being 10 ohms, the battery in the FIG. 12 operating mode sees a resistance of 1.66 ohms. All of the resistance-heating elements passes the same current. As such, this may be considered a relatively high-power, even distribution mode.

It will be appreciated that FIGS. 8 to 12 show only a small number of operating modes out a large number of potential operating modes for heating circuit 800. Different combinations of switches may be controlled by controller 800 to adjust the total power output by heating circuit 800 and/or the distribution of power across the resistance-heating elements of heating circuit 800.

The skilled person will appreciate that batteries have an internal resistance, which for simplicity is neither shown nor included in the resistance calculations above. Arranging the resistance-heating elements into a ring allows the resistance presented to the battery to be managed, thereby reducing the I2C losses in the battery. For example, heating circuits of the type described can be designed so that maximum power is drawn with all the switching elements turned on, or with just pairs of adjacent switches (e.g., first switching element 826 and second switching element 828, and third switching element 830 and fourth switching element 832 of FIG. 8). The latter (paired) approach may allow for reduced peak current draw for a given overall temperature, by generating a moving “hotspot” generated by pairs of the resistance heating elements.

FIG. 13 shows an alternative heating circuit 900, which uses numbering corresponding to that used in FIGS. 8 to 12. The skilled person will appreciate that heating circuit 900 operates in a similar fashion to that of heating circuit 800, but with a smaller number of resistance-heating elements. Operation of heating circuit 900 is not described in detail, as the skilled person will understand its operation based on the description of how heating circuit 800 operates.

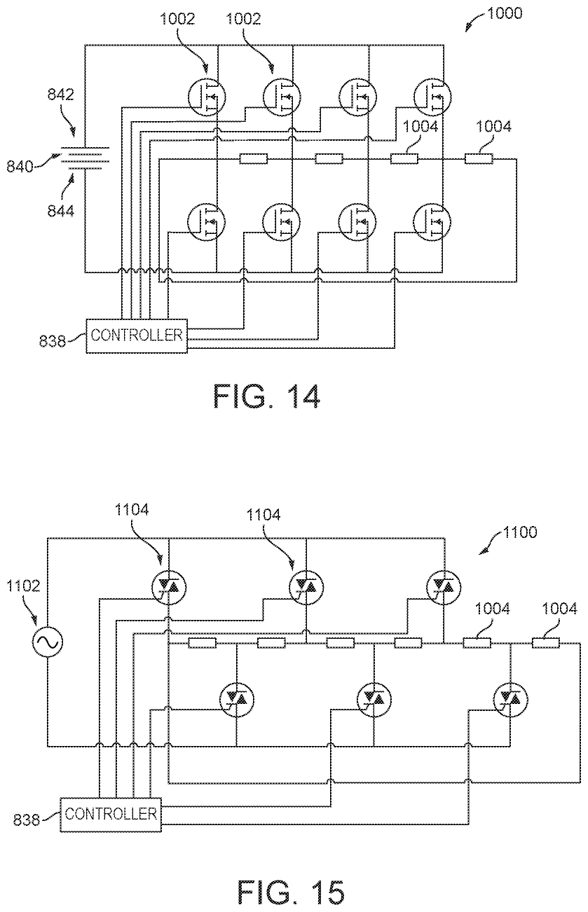

FIG. 14 shows an alternative heating circuit 1000, which uses numbering corresponding to that used in FIGS. 8 to 13. The skilled person will appreciate that heating circuit 1000 operates in a similar fashion to that of heating circuits 800, but with a larger number of switching elements 1002 and only four resistance-heating elements 1004. In particular, each node is connected to the positive terminal 842 and negative terminal 844 via two independent switching elements 1002. This arrangement provides a wider range of potential operating modes compared to heating circuit 800, at the cost of additional switching elements and the need for a controller capable of controlling those switching elements.

While FIG. 14 shows two switches connected to each node, the skilled person will appreciate that any node can potentially be connectable to any number of voltages. For example, some can be connectable to only a single voltage via a switch, some can be connectable to two voltages via two respective switches, and so on for three (and greater) voltages. Similar comments apply to different phases where an AC power supply is used.

Depending upon implementation, switching elements in a DC-powered device may be controlled to act as solid-state relays with a relatively long “on” period (several seconds or more, for example). Alternatively, or in addition, they may be switched at relatively high speed, with some form of modulation (such as pulse-width modulation or pulse-density modulation) to control power output over time. The same modulation may be applied across all resistance-heating elements together, or different modulation may be applied to any subset of the resistance-heating elements.

FIG. 15 shows an alternative heating circuit 1100, which uses numbering corresponding to that used FIGS. 8 to 14. The main difference is that an AC power supply 1102 is used instead of battery 840 as used in heating circuit 800. The AC power supply 1102 may be configured to be plugged into a mains socket by way of a suitable plug, or may be powered by an inverter (whether on- or off-board). In addition, the switching elements in heating circuit 1100 take the form of triacs 1104, rather than MOSFETs as used in heating circuit 800. Operation of heating circuit 1000 is not described in detail, as the skilled person will understand operation based on the description of how heating circuit 800 operates.

Heating circuits such as those above may find particular application in devices, such as hair-styling devices, having a plurality of heating zones, and are described with reference to examples of such devices. However, the heating circuit of the present invention may be employed in many other devices and applications, including those others described herein.

While the heating circuits described above have identical resistance-heating elements, the resistance-heating elements need not be identical. For example, one or more of the resistance-heating elements may have a different power rating as compared to one or more other resistance-heating elements. The resistance-heating elements may be provided with any combination of power ratings, dependent upon the application to which the heating circuit is to be put. Different power ratings for one or more of the resistance-heating elements may enable a wider range of total power output to be achieved. Alternatively, or in addition, different power ratings for one of more of the resistance-heating elements may enable a different distribution of power across the resistance-heating elements. As one example, for a hair-straightening device, it may be useful to use less powerful resistance-heating element(s) near the tip of the device, where less hair tends to be in contact when the device is in use.

Alternatively, or in addition, one or more of the resistance-heating elements may have a different power distribution by surface area as compared to one or more other resistance-heating elements. The resistance-heating elements may be provided with any combination of power distributions by surface area, dependent upon the application to which the heating circuit is to be put. Different power distributions by surface area for one or more of the resistance-heating elements may enable different power outputs across the surface area of a device. For example, this may enable a device comprising the elements to have different temperature zones or areas, despite each heating element having the same power rating.

Alternatively, or in addition, one of more of the resistance-heating elements may have a different surface area or volume as compared to one or more other resistance-heating elements. The resistance-heating elements may be provided with any combination of surface area and/or volume, dependent upon the application to which the heating circuit is to be put.

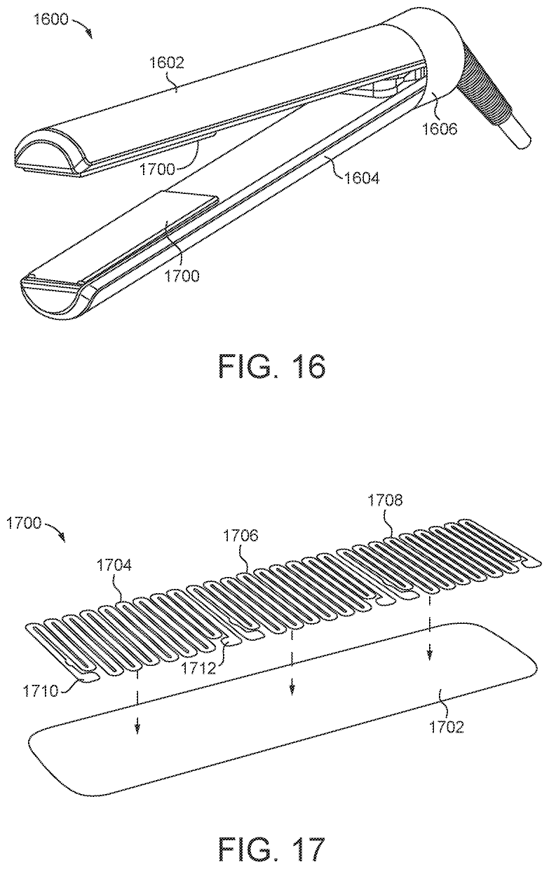

A specific application will now be described with reference to FIGS. 16 and 17. FIG. 16 is a perspective view of a hair-straightening device 1600. Hair-straightening device 1600 takes the general form of set of tongs, comprising a pair of elongate elements 1602 and 1604, joined at a hinged end 1606. A spring (not shown) urges elongate elements 1602 and 1604 apart. A power cord 1608 extends from hinged end 1606, terminating in a power plug (not shown) that may be plugged into a power outlet. Each of elongate elements 1602 and 1604 has a pair of subassemblies 1700 that are heated as described below when hair-straightening device 1600 is in use.

FIG. 17 is an exploded view showing a subassembly 1700 of the hair-straightening device 1600, the subassembly 1700 comprising a thermally-conductive substrate 1702. The subassembly 1700 comprises a first resistance-heating element 1704, a second resistance-heating element 1706 and a third resistance-heating element 1708. Each of resistance-heating elements 1704, 1706 and 1708 takes the form of a resistive trace on an electrically-insulating substrate. The resistance-heating elements 1704, 1706 and 1708 are mounted to conductive substrate 1702 such that heat generated by the resistance-heating elements is conducted into the substrate 1702, to form a heating zone on a surface of the substrate 1702 opposite the resistance-heating elements. Each of resistance-heating elements 1704, 1706 and 1708 includes a first terminal 1710 and a second terminal 1712 to which drive circuitry can be connected.

In use, hair-straightening device 1600 is plugged in and a controller (such as controller 838 described in relation to other examples) controls heating elements 1704, 1706 and 1708 such that they heat up and transfer heat to adjacent heating zones on the thermally-conductive substrate 1702.

Although not shown in the drawings for clarity, one or more temperature sensors may be provided to enable temperature-based control of the resistance-heating elements. For example, one or more temperature sensors may be provided per heating element, and/or per zone heated by any combination of heating elements. As an example, a temperature sensor may be located generally centrally to each resistance-heating element, but other locations may be used depending upon the implementation. A controller may accept signals from the temperature sensor(s) as feedback inputs to assist in determining how to drive the heating elements.

A device comprising one or more of the described heating elements may be operable in one or more modes, which may operate automatically and/or under user control. For example, a rapid-heat mode may automatically be engaged at switch-on, and the device may automatically enter a low-power standby mode if not used for some time. Alternatively, or in addition, a user may select various modes in which different areas of the device may have different temperatures. For example, in one mode, the entire heating surface of a device may be at a constant temperature, whereas in other modes, different regions may be maintained at different temperatures.

Mode selection may be made by way of any suitable interface, which may include, for example, one or more switches, dials, sliders, touchpads, or touchscreens. Alternatively, or in addition, mode selection may be controlled remotely, such as via a smartphone app. Where such remote control is implemented, the device includes a communications module (not shown), which interfaces with the controller in a manner known to the skilled person.

Depending on implementation choices, several potential advantages may flow from the described heating circuits. The use of at least three serially-connected resistance-heating elements may offer multiple heat output and/or distribution options. The flexibility of such heating circuits, and the ability to localise heat and customise heat gradients, increases as the number of heating elements and switches increases. The number of combinations may also increase where the resistance-heating elements are serially connected to form a ring circuit.

Controlling individual switching elements may also allow for phased or sequential turning on of the switching elements, which may reduce a peak current that the power supply (e.g., battery) needs to supply.

Although various heating circuits have been described with reference to hair-styling devices such as hair-straighteners, hair-curlers and hair-crimpers, the skilled person will appreciate that such heating circuits have application outside this general field.

1. A heating circuit, comprising at least three series-connected resistance-heating elements, each resistance-heating element being connected between a pair of nodes, each pair of adjacent resistance-heating elements in the series being connected via one of the nodes, each node being connectable to a voltage.

2. The heating circuit of claim 1, comprising a first switching element, wherein:
a first terminal of the first switching element is connectable to a first voltage; and
a second terminal of the first switching element is connected to a first of the nodes, the first switching element being switchable to enable selective connection of the first node to the first voltage.

3. The heating circuit of claim 2, comprising a second switching element, wherein:
a first terminal of the second switching element is connectable to the first voltage or to a second voltage that is different to the first voltage; and
a second terminal of the second switching element is connected to a second of the nodes, the second switching element being switchable to enable selective connection of the second node to the first voltage or the second voltage.

4. The heating circuit of claim 3, wherein the first and second switching elements are independently switchable to define multiple parallel-resistance combinations of the resistance-heating elements, wherein each combination results in, relative to at least some of the other combinations:
a different combined power output of the resistance-heating elements; and/or
a different distribution of power output across the resistance-heating elements.

5. The heating circuit of claim 2, comprising a third switching element, wherein:
a first terminal of the third switching element is connectable to the first or second voltage, or to a third voltage; and
a second terminal of the third switching element is connected to one of the nodes, the third switching element being switchable to enable selective connection of the third node to the first voltage, the second voltage or the third voltage.

6. The heating circuit of claim 5, wherein the second terminal of the third switching element is connected to a node other than the first node and the second node.

7. The heating circuit of claim 5, wherein the second terminal of the third switching element is connected to the first node or the second node.

8. The heating circuit of claim 1, wherein the series-connected resistance-heating elements comprise one or more additional resistance-heating elements.

9. The heating circuit of claim 1, wherein the resistance-heating elements are connected as a ring circuit.

10. The heating circuit of claim 9, comprising at least four of the resistance-heating elements, each connected to its adjacent resistance-heating element(s) via one of the nodes.

11. A device comprising the heating circuit of claim 1.

12. The device of claim 11, comprising a heating surface having a plurality of heating zones, each of the zones being heatable by at least one of the resistance-heating elements, the heating device comprising drive circuitry for selectively driving combinations of the nodes with voltages, such that different combinations of voltages connected to at least two of the nodes at a time allow selection of respective corresponding parallel-resistance combinations of the resistance-heating elements, wherein each combination results in, relative to at least some of the other combinations:
a different combined power output of the resistance-heating elements; and/or
a different distribution of power output across the resistance-heating elements.

13. The device of claim 12, wherein the heating zones extend in a linear direction along a portion of the device.

14. The device of claim 11, wherein the device is in the form of a hair-styling apparatus.

15. The device of claim 14, wherein the hair-styling apparatus takes the form of:
a hair-straightening apparatus;
a hair-curling apparatus; or
a hair-crimping apparatus.

16. A hair-styling apparatus comprising:
an array of heating zones;
a heating circuit, comprising at least three series-connected resistance-heating elements, each resistance-heating element being connected between a pair of nodes, each pair of adjacent resistance-heating elements in the series being connected via one of the nodes, each resistance-heating element being arranged to heat at least one of the heating zones;
drive circuitry for selectively supplying different combinations of voltages to at least two of the nodes at a time to allow selection of respective corresponding parallel-resistance combinations of the resistance-heating elements, wherein each combination results in, relative to at least some of the other combinations:
a different combined power output of the heating zones; and/or
a different distribution of power output across the heating zones.

17. The device of claim 11, further comprising a battery for powering the heat elements.

18. The hair-styling apparatus of claim 16, further comprising a battery for powering the heat elements.
